(19) United States
(12) Patent Application Publication
(10) Pub. No.: US 2004/0258341 A1
(43) Pub. Date: Dec. 23, 2004

(54) Optical waveguide with radiation-tuned birefringence

(76) Inventors: Dora M. Paolucci, Austin, TX (US); James R. Onstott, Dresser, WI (US); Craig R. Sykora, New Richmond, WI (US); Ding Wang, Austin, TX (US)

Correspondence Address: 3M INNOVATIVE PROPERTIES COMPANY, PO BOX 33427, ST. PAUL, MN, 55133-3427, US

(21) Appl. No.: 10/465,154

(22) Filed: Jun. 19, 2003

(51) Int. Cl. G02F 1/295; G02B 6/00

(52) U.S. Cl. 385/4; 385/141

(57) ABSTRACT

A radiation tuned optical fiber comprises an optical fiber that includes a substantially circular core and a cladding containing an asymmetric stress zone. The substantially circular core has an initial birefringence. A length of the optical fiber has at least one radiation-tuned portion wherein the substantially circular core has a tuned birefringence to provide the radiation tuned optical fiber in which the tuned birefringence differs from the initial birefringence.

### BACKGROUND OF THE INVENTION

1. Field of the Invention

The invention relates to optical waveguides having birefringence attributable to an asymmetric cladding layer and a method for selectively changing birefringence along a length of an optical waveguide corresponding to changes occurring in the asymmetric cladding. More particularly the present invention provides a polarization-maintaining optical fiber having, in its length, at least one radiation tuned portion that differs in birefringence from the effective birefringence of the optical fiber as drawn.

2. Description of the Related Art

Light passing through a birefringent material, unless it is incident along a polarization axis, undergoes transformation to produce a pair of polarized modes having an orthogonal relationship to each other. All optical fibers have inherent birefringence due to deviation from ideal circular symmetry across the core or cladding layers or both of these regions of the optical fiber. Optical fiber birefringence may be desirable or undesirable depending upon the requirements of a particular application. A variety of applications rely upon highly birefringent polarization maintaining optical fibers to respond to changes associated with variable physical parameters to provide measuring instruments or interferometers used in optical sensing devices. U.S. Pat. No. 4,603,941 describes an optical sensor using a polarization maintaining optical fiber responsive to dimensional changes of a body located inside the optical fiber. The body expands and contracts with change of temperature causing change in the birefringence of the optical fiber, which stretches or relaxes as the body dimensions change. The optical sensor uses a spectrum analyzer to provide read-out following changes in birefringence corresponding to changes in temperature. In this case, temperature is the variable parameter that produces stress induced birefringence variation in an optical fiber. Stress induced changes of birefringence occur in response to a range of variables including, for example, compressive stresses, bending and twisting forces, acoustic pressure and direct exposure of an optical fiber to changes in temperature. Any of these variables produce measurable changes in birefringence when applied to a suitable optical fiber structure.

Different types of birefringent optical fibers exist to satisfy the requirements of a variety of applications. Birefringence may be associated with the shape and dimensions of the optical fiber core, the optical fiber cladding or the placement of components relative to the core and cladding. U.S. Pat. No. 4,274,854 describes a method for forming an optical fiber preform that yields an optical fiber wherein the polarization of transmitted radiation is preserved by a combination of asymmetric geometry and stress birefringence. The optical fiber has a circular or slightly elliptical core surrounded by a geometrically asymmetric, stress inducing cladding region. Geometrical asymmetry introduces asymmetric stress that causes the optical fiber to exhibit birefringence. Asymmetric stress may be introduced into an optical fiber using structural features that do not include an elliptical cladding layer. U.S. Pat. No. 4,515,436 uses a pair of stress lobes creating sufficient stress birefringence to split the fundamental mode traveling down the core region of the optical fiber into two orthogonal polarizations. The stress lobes have a circular cross section consistent with commercially available polarization maintaining optical fibers identified as PANDA fibers commonly used in telecommunications applications. Circular cross-section stress lobes may be replaced using stress lobes of different shape including the opposing arcuate sections of BOW-TIE type polarization maintaining optical fibers. It is possible, therefore, to fabricate polarization maintaining fibers in which stress asymmetry, associated with design of cladding layers, is revealed when radiation passing through the core of an optical fiber splits into two orthogonal polarizations. As indicated previously, the inherent birefringence of a polarization maintaining optical fiber may be changed by application of external stresses including compressive stress, bending and twisting forces and the like not only to provide measuring devices but also to control the wave characteristics and phase relationships of polarized modes propagating through lengths of optical fiber, as required for polarization couplers and wavelength filters.

The need to increase or suppress optical fiber birefringence has particular significance for known optical fiber devices that rely on the photosensitivity of an optical fiber for fabrication of a variety of in-fiber filters such as Bragg gratings and rocking filters. Optical fibers used for Bragg gratings preferably exhibit very low birefringence. Conversely, fabrication of rocking filters requires highly birefringent optical fibers. A rocking filter has been described by R. H. Stolen et al. (Optics Letters Vol. 9, No. 7, page 300 and U.S. Pat. No. 4,606,605) as an in-line fiber polarization rotator and filter formed in a birefringent single-mode fiber wherein the fiber's principal axes are periodically rocked, during fiber drawing, with a period equal to the fiber's birefringence beat length. Polarization conversion occurs in the fiber rotator by a type of phase-matched coupling that was previously employed in fiber polarization rotators using small externally applied twists or stresses to a previously drawn optical fiber. Fabrication of polarization rotators, according to Stolen et al., uses mechanical manipulation of a preform to periodically rock the polarization axes of the optical fiber. Preform manipulation introduces periodic changes throughout the optical fiber structure that includes the core and surrounding layers of cladding.

Psaila et al., and others, (Appl. Phys. Lett. Vol. 68, No. 7, page 900 and related articles) have shown that rocking filters may be obtained using ultraviolet radiation to periodically rock the fiber's principal axes through a small angle. Since the birefringent beat length of the optical fiber is wavelength dependent, there is a resonant wavelength at which the beat length is equal to the rocking filter twisting period. At this wavelength there is complete coupling from one polarization mode to the other, while at other wavelengths there is only partial coupling.

According to Psaila et al (see above) there is no clear understanding of the microscopic phenomena that cause rotation of the birefringent axes of an elliptical core of a germania doped silica fiber exposed to ultraviolet radiation. However, the observation of an anisotropic change of refractive index accompanying formation of Bragg gratings, by exposure to ultraviolet radiation, suggests that anisotropy may account for photoinduced changes of birefringence in rocking filters. Further investigation of photoinduced birefringence in germanosilicate elliptical core fibers and hydrogen-loaded germanosilicate elliptical core fibers, by Psaila et al., provided short rocking filters having a wide bandwidth and reduced temperature dependence making them useful in sensor applications.

Fabrication of Bragg gratings, by exposure to ultraviolet radiation, requires periodic change of refractive index along an optical fiber core that is essentially free from birefringence. Rocking filters also require a periodic variation of properties, but in this case the change occurs periodically to alter the birefringence of an inherently birefringent optical fiber that has a photosensitive elliptical core exposed to ultraviolet radiation at points along a length of the optical fiber determined by the birefringence beat length.

Review of known structures for optical fibers and consideration of the variety of known applications, based upon changes in the structures and properties of optical fibers, suggests a continuing need to investigate changes in property and structural relationships of optical fibers subjected to various forms of stress and radiant energy. Discovery of new phenomena could provide the basis for a range of new applications in the field of optical fibers.

### SUMMARY OF THE INVENTION

The present invention provides an optical waveguide that includes at least one portion of radiation-tuned birefringence. Preferably the optical waveguide is a single mode polarization maintaining or polarizing optical fiber. Polarization maintaining (PM) optical fibers are useful for providing efficient coupling between single mode fibers and polarization sensitive optical devices and for achieving maximum gains in fiber Raman and parametric oscillators and amplifiers.

Several types of known single mode PM optical fibers include an asymmetric region in their structures. Polarization maintaining optical fibers according to the present invention comprise a core having a substantially circular cross section, at least one cladding layer, providing an asymmetric stress region contributing to stress-induced birefringence in the optical fiber core, and one or more coatings over the cladding layer. Birefringence occurs when an optical fiber exhibits a refractive index in a first polarization mode that differs from the refractive index in a second polarization mode orthogonal to the first. The magnitude of birefringence of an optical fiber is the difference in index of refraction between the two polarization modes. Due to deviation from circular cross section, all optical fibers have some level of -birefringence. Most standard single mode optical fibers are substantially non-birefringent. They contain a substantially circular core region and have minor levels of birefringence, typically between 10⁻⁵ and 10⁻⁷. The amount of birefringence may be adjusted using an asymmetric cladding region of an optical fiber and varying the dimensions to produce PM optical fibers or polarizing (PZ) optical fibers having values of birefringence from as low as 10⁻⁵ up to at least 10⁻³.

An optical fiber structure may be designed in several known ways to provide an asymmetric, stress-inducing cladding region along the length of the fiber. Descriptive terms including PANDA, BOW-TIE and Stress Ellipse designate known structures for single mode PM optical fibers. The commercially available PANDA design incorporates two circular stress regions produced by boring holes in a preform and inserting a stress rod in each of the holes. Stress rods having a coefficient of thermal expansion (CTE) greater than other materials in the preform generate stress-inducing asymmetry in the cladding that causes an increase of birefringence in the core of a drawn optical fiber. BOW-TIE PM, single mode, optical fibers have a stress region produced by fan-shaped, arcuate stress elements in a cladding region on either side of a circular optical fiber core. Viewed in cross section the combination of stress elements and substantially circular core have the appearance of a bow tie, hence the name assigned to commercially available PM optical fibers of this type.

A single mode optical fiber having the Stress Ellipse design requires a circular preform that includes a cladding layer having a high coefficient of thermal expansion. Fabrication of a PM optical fiber of this type involves grinding the edges of the preform. During drawing of an optical fiber the cladding layer expands towards the ground edges to produce an optical fiber having circular cross section. As the cladding expands it applies asymmetric, i.e. non-cylindrically-symmetric, stress on the circular core of the optical fiber, which develops birefringent axes and PM behavior attributable to stress birefringence.

Changes in the chemical composition and geometry (aspect ratio) of the elliptical cladding layer produce a range of PM fibers including fibers in which elongation of the stress geometry creates a polarizing (PZ) or single polarization optical fiber. A highly elongated ellipse produces a large difference of refractive index in the optical fiber core so that, in combination with the depressed well design, one of its,polarization axes no longer guides the fundamental mode of light incident upon the optical fiber. Simpson et al (Journal of Lightwave Technology, vol. LT-1, No. 2, pages 370-374, June 1983) provide an explanation of this phenomenon by describing how stress induced splitting of the two perpendicular polarizations of the fundamental mode produces one polarization that is attenuated by tunneling into the outer cladding while the other polarization propagates with low loss.

It is expected that any type of a polarization maintaining optical fiber may be used to provide at least one portion of tuned birefringence in the length of the optical fiber. Although the following information addresses the introduction of tuned birefringence into PM optical fibers of the Stress Ellipse design, the use of other types of PM optical fibers falls within the scope of the present invention.

The preferred structure of a single mode, PM optical fiber, suitable for radiation tuning of birefringence according to the present invention, includes a core, a cladding and a jacket surrounding the cladding. Suitable cladding layers may have one or more asymmetric stress applying regions and an inner barrier, exemplified by a depressed index cladding layer, between the circular core and the stress applying region or regions. The composition of an asymmetric stress-applying layer of the stress ellipse type will vary depending on the application. One significant compositional difference between stress ellipse type PM optical fibers and others, such as PANDA and BOW-TIE PM fibers, is the concentration of germanium oxide used as a dopant in the stress layer, also referred to herein as the asymmetric stress zone.

Introduction of germanium dopants into the core of a glass optical fiber is known to increase the core's absorption of ultraviolet radiation. A benefit of germanium doping accrues to fabrication of fiber refractive gratings and rocking filters that include periodic changes of refractive index and birefringence respectively. These periodic changes occur during exposure of the core of a germanosilicate optical fiber to a pattern of ultraviolet radiation. A number of references suggest that formation of rocking filters requires an optical fiber having a core of elliptical cross section. In the case of refractive index gratings, such as Bragg gratings, a primary objective is grating formation without increasing the birefringence of the processed optical fiber.

The present invention uses actinic radiation, particularly ultraviolet radiation, to tune a single mode PM optical fiber. Optical fiber tuning produces a change in phase relationship between orthogonally polarized light waves corresponding to an increase in birefringence of a radiation tuned portion of an optical fiber through which the light waves pass. While not wishing to be bound by theory, it appears that radiation tuning, corresponding to a change in birefringence of the optical fiber core, results from changes in the stress applying cladding region or asymmetric stress zone containing relatively high concentrations of dopant compositions, particularly dopant compositions containing germanium compounds.

A method for producing a length of PM optical fiber having a portion of radiation tuned birefringence requires that the portion be exposed to radiation of a wavelength that is absorbed by, for example, the germanium-doped asymmetric stress layer of the optical fiber cladding. Coatings may be removed from coated optical fibers to facilitate radiation tuning. The method may use a translation stage that provides clamping points to hold a fixed length of PM single mode, optical fiber. A suitable range of fixed lengths of optical fiber varies between about one millimeter and about eight centimeters. During radiation tuning of birefringence, the stage translates in front of a stationary spot of high intensity radiation from an ultraviolet laser operating at a wavelength of 244 nm. The laser light spot illuminates the side of the length of a PM optical fiber during scanning at rates of about 0.1 mm/second to about 0.5 mm/second. Although described above in terms of optical fiber movement, it is within the scope of the present invention to accomplish radiation tuning of an optical fiber using a laser beam directed towards a stationary optical fiber with or without scanning.

Optical fibers having portions of radiation tuned birefringence were evaluated using a magneto-optic modulation technique to reveal that the beat length of the radiation tuned portion differed from the beat length of other parts of the PM optical fiber that were left untreated. Apart from the radiation tuned portion, the length of optical fiber retained the same level of birefringence as that associated with the original PM optical fiber formed in the optical fiber draw tower. The change in beat length, which appears to be permanent, causes a change in phase relationship of orthogonally polarized light waves entering the portion of radiation tuned birefringence. Radiation treatment of a PM optical fiber, as described above, typically increases birefringence while lowering the beat length of the radiation tuned portion.

More particularly the present invention provides a radiation tuned optical fiber comprising an optical fiber including a core and a cladding containing an asymmetric stress zone. The core has an initial birefringence. A radiation tuned optical fiber includes at least one radiation-tuned portion wherein the core has a tuned birefringence that differs from the initial birefringence.

The present invention also provides a process for producing a radiation tuned optical fiber comprising several steps. The first step provides an optical fiber including a core, a cladding containing an asymmetric stress zone and at least one coating covering the cladding. The core further has an initial birefringence. Exposing a portion of at least one section of the optical fiber to actinic radiation provides at least one radiation tuned portion of the at least one section, such that the core has a tuned birefringence to provide the radiation tuned optical fiber wherein the tuned birefringence differs from the initial birefringence.

Other steps in the process include removing the at least one coating from the at least one section of the optical fiber and the step of annealing the radiation tuned optical fiber.

Radiation tunable optical fibers according to the present invention provide a wavelength tunable optical device comprising at least one polarization maintaining optical fiber having a length, a first end, a second end, an initial birefringence and a first polarization axis orthogonally disposed to a second polarization axis. The polarization maintaining optical fiber receives polarized light from a first polarizer adjacent to the first end of the polarization maintaining optical fiber. Polarized light from the first polarizer has a first fixed polarization axis forming a first selected angle with the first polarization axis and the second polarization axis, A second polarizer, adjacent to the second end of the polarization maintaining optical fiber, has a second fixed polarization axis for receiving a light output from the second end of the polarization maintaining optical fiber. The light output includes light polarized along the first polarization axis and the second polarization axis such that the second fixed polarization forms a second selected angle with each of the first and second polarization axes. A wavelength tunable optical device provides a plurality of spectral peaks leaving the second polarizer. The plurality of spectral peaks has a periodicity determined by the length of the polarization maintaining optical fiber and each of the plurality of spectral peaks has a wavelength dependent upon the length and the initial birefringence. The polarization maintaining optical fiber is a radiation tunable optical fiber adaptable to a tuned birefringence in which the periodicity and each the wavelengths change to a selectively tuned wavelength and a tuned periodicity.

The present invention also includes a process for producing a wavelength tuned optical fiber device. A suitable process includes a number of steps beginning with providing a wavelength tunable optical fiber device. The device comprises at least one polarization maintaining optical fiber including a core, a cladding containing an asymmetric stress zone and at least one coating covering the cladding. The polarization maintaining optical fiber has a length, a first end, a second end, an initial birefringence and a first polarization axis orthogonally disposed to a second polarization axis. A wavelength tunable optical fiber device also includes a first polarizer adjacent to the first end of the polarization maintaining optical fiber. The first polarizer provides polarized light having a first fixed polarization axis forming a first selected angle with each of the first polarization axis and the second polarization axis. A second polarizer, included in the wavelength tunable optical fiber device, adjacent to the second end of the polarization maintaining optical fiber, has a second fixed polarization axis for receiving a light output from the second end of the polarization maintaining optical fiber. The light output includes light polarized along the first polarization axis and the second polarization axis such that the second fixed polarization axis forms a second selected angle with each of the first and second polarization axes. Exposing a portion of at least one section of the polarization maintaining optical fiber to actinic radiation provides at least one radiation tuned portion of the at least one section, such that the portion has a tuned birefringence to provide the wavelength tuned optical fiber device wherein the tuned birefringence differs from the initial birefringence.

The process of forming a wavelength tuned optical fiber device according to the present invention may require the step of removing the at least one coating from the at least one section of the optical fiber if the coating causes attenuation of the actinic radiation. Also, after radiation tuning it may be necessary to anneal the wavelength tuned optical fiber device at a suitable elevated temperature.

Definitions

The term “initial birefringence” refers to the birefringent properties of the core of a polarization maintaining optical fiber, preferably a single mode PM optical fiber, occurring with fabrication of the optical fiber in e.g. a draw tower. As drawn, a PM optical fiber has an asymmetric stress region or zone existing in a first condition that causes the initial birefringence of the core.

Terms including “radiation tuned birefringence” “tuned birefringence,” “wavelength tuned birefringence” and the like, refer to modification of a polarization maintaining optical fiber, preferably a single mode PM optical fiber, by exposure to radiation of chosen wavelength to selectively tune a portion of a section of the length of the PM fiber by increasing the birefringence, of a substantially circular core that is surrounded by an asymmetric stress region of the optical fiber cladding. After radiation tuning, the characteristics of the asymmetric stress region change to a second condition that causes the tuned birefringence of the core in the tuned portion of the PM optical fiber.

Terms including “stress region,” “stress inducing asymmetry,” “stress composition,” “asymmetric stress zone” and the like, refer to the structure and composition of the component parts of PM optical fibers that provide stress induced birefringence characteristic of a selected PM optical fiber. For example a PANDA design incorporates two circular stress regions produced by boring holes in a preform and inserting a stress rod in each of the holes. The composition of the stress rods, i.e. the stress composition, has a coefficient of thermal expansion (CTE) greater than other materials in the preform to generate stress-inducing asymmetry in the cladding region that causes the circular core of a drawn optical fiber to exhibit birefringence.

The term “BOW-TIE” describes a type of PM optical fiber also used widely in the telecommunications industry. This type of optical fiber incorporates a cladding having opposing stress regions, identifiable as fan shaped, arcuate structures that apply asymmetric stress to the substantially circular core of the optical fiber making it birefringent.

The term “Stress Ellipse” describes a type of PM optical fiber produced from a circular preform that includes a cladding layer having a high coefficient of thermal expansion. Fabrication of a PM optical fiber of this type involves grinding the edges of the preform. During drawing of an optical fiber the cladding layer expands towards the ground edges to produce an optical fiber having circular cross section. As the cladding expands it applies asymmetric, i.e. non-cylindrically-symmetric, stress on the circular core of the optical fiber, which develops birefringent axes and PM behavior attributable to stress birefringence. Compositional and geometrical (aspect ratio) changes of the Stress Ellipse design produce PM optical fibers for a variety of applications. Typically a polarizing, i.e. single polarization, (PZ) optical fiber is an optical fiber of the Stress Ellipse type. The PZ optical fiber has a depressed well design in which the relative refractive indices of the core and the inner cladding only allow transmission of the fundamental mode along one axis providing an optical fiber transmitting only a single polarization mode of light.

The term “Polarizer” is used generally herein with reference to any one of a number of polarization elements exemplified by a bulk polarizer and a fiber optic polarization beam splitter and the like.

The term “Birefringence” refers to the difference in refractive indices (Δn) between the fast and slow axes of a birefringent material or structure such as a PM optical fiber.

The “Beat length” (l) of a selected wavelength (λ) passing through a birefringent structure such as a PM optical fiber is given by the relationship:

l=λ/Δn

The above summary of the present invention is not intended to describe each disclosed embodiment or every implementation of the present invention. The Figures and the detailed description, which follow, more particularly exemplify illustrative embodiments.

### BRIEF DESCRIPTION OF THE DRAWINGS

FIG. 1 provides a schematic illustration of the cross section of one form of commercially available polarization maintaining optical fiber.

FIG. 2 is a schematic cross section of an alternative form of commercially available polarization maintaining optical fiber.

FIG. 3 is schematic cross section through a polarization maintaining optical fiber of the Stress Ellipse type.

FIG. 4 provides a schematic diagram of an apparatus used for radiation tuning of polarization maintaining optical fibers according to the present invention.

FIG. 5 provides a trace showing the change in beat length for a polarization maintaining optical fiber after radiation tuning according to the present invention.

FIG. 6 shows how exposure to ultraviolet radiation changes the refractive index profile across the width of a polarization maintaining optical fiber having a germanium doped stress layer.

FIG. 7 shows the minimal change of refractive index profile when germanium dopant is absent from the stress layer of a polarization maintaining optical fiber.

FIG. 8 is a perspective view illustrating an all-fiber, radiation tunable optical filtering device.

FIG. 9 provides evidence of changing wavelength of a radiation tunable optical filtering device of FIG. 8 as a function of exposure to suitable radiation.

FIG. 10 shows output wavelength increase for an all fiber radiation tunable optical filtering device that includes a section of polarization maintaining, birefringent optical fiber seven meters long.

FIG. 11 provides a schematic diagram of a radiation tunable optical fiber device.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

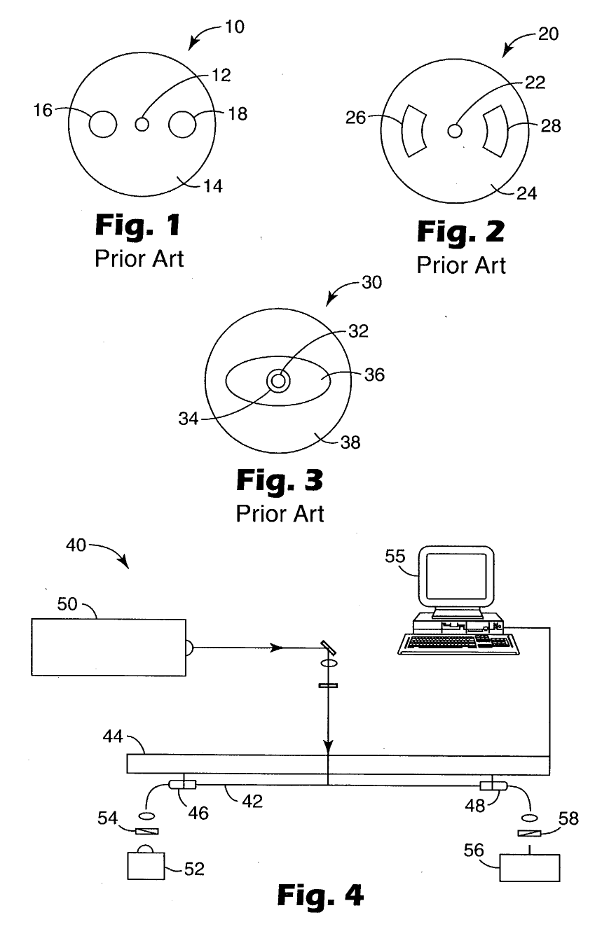

Referring now to the figures wherein like numerals represent like parts throughout the several views, FIG. 1 provides a cross section through the core and cladding of a polarization maintaining optical fiber (10), commercially available under the trade-name PANDA. The PANDA optical fiber has a substantially circular core (12) surrounded by a cladding (14) that contains a first stress rod (16) and a second stress rod (18), each of which has a circular cross section. Placement of the stress rods (16, 18) in an opposing relationship, on either side of the optical fiber core (12) generates an asymmetric stress across the polarization maintaining optical fiber. An asymmetric stress develops in the optical fiber (10) because the coefficient of thermal expansion of the stress rods (16, 18) differs from the coefficient of thermal expansion (CTE) of the cladding (14). Asymmetric stress induces birefringence in the optical fiber core (12).

FIG. 2 provides a cross section through the core and cladding of a polarization maintaining optical fiber (20) that is commercially known under the designation BOW-TIE. The BOW-TIE optical fiber has a substantially circular core (22) surrounded by a cladding (24) that contains a first stress element (26) and a second stress element (28), each of which has a somewhat fan shaped, arcuate cross section. Placement of the stress elements (26, 28) in an opposing relationship, on either side of the optical fiber core (22) generates an asymmetric stress across the polarization maintaining optical fiber. As for the PANDA optical fiber (10), there is a difference in the CTE of the cladding (24) and the stress elements (26, 28), which produces the asymmetric stress and birefringence in the core (22) of the optical fiber (20).

FIG. 3 shows a cross section through the core and cladding layers of a polarization maintaining optical fiber (30) that is commercially known under the designation Stress Ellipse. The Stress Ellipse optical fiber has a substantially circular core (32) surrounded by an inner cladding (34) and an intermediate cladding (36), having the shape of an ellipse, and an outer cladding (38). The non-circular, elliptical intermediate cladding (36) produces asymmetric stress across the optical fiber core (32). As in the previous cases, asymmetric stress causes birefringence in the optical fiber (30). The degree of birefringence increases as the intermediate cladding (36) develops a more distinctly elliptical cross section.

TABLE 1
Optical And Geometric Properties Of Selected Fibers

| | | | | Operating | | Major | Minor |
|---|---|---|---|---|---|---|---|
| | | | MFD | wavelength | | axis | axis |
| Fiber | Used for | Type | (μm) | (nm) | Birefringence | (μm) | (μm) |
| 1 | Examples | Stress Ellipse | 10.4 | 1480 | 4 × 10⁻⁴ | 89 | 40 |
| | 1-6 | | | | | | |
| 2 | Temperature | Stress Ellipse | 8.9 | 1480 | 2 × 10⁻⁴ | 49 | 20 |
| | stabilization | coupler fiber | | | | | |
| 3 | Examples | Stress Ellipse | 9.0 | 1480 | 8 × 10⁻⁵ | 32 | 14 |
| | 7-14 | coupler fiber | | | | | |
| 4 | Examples | Stress Ellipse | 7.8* | 1550 | 9.7 × 10⁻⁴ | 72 | 17 |
| | 15-19 | polarizing | | | | | |
| 5 | | Bow-tie | 9.5 | 1550 | 3.4 × 10⁻⁴ | N/A | N/A |
| 6 | | Panda | 9.8 | 1550 | 4 × 10⁻⁴ | N/A | N/A |
| 7 | | Stress Ellipse | 4.8† | 980 | 4 × 10⁻⁴ | 44 | 21 |

*Measured at 1100 nm
†Measured at 980 nm

The present invention provides a single mode polarization maintaining (PM) optical fiber having a single portion or multiple portions of its length modified by exposure to actinic radiation of selected wavelength. Radiation tuning, according to the present invention, should be an effective treatment for PM optical fibers, where suitable photosensitive versions are avialable, including PM fibers exemplified by PANDA optical fibers (available from Corning Inc., Corning, N.Y.), optical fibers recognizable by the trade designation BOW-TIE available from FiberCore Inc., Southampton, UK, and PM optical fibers of the Stress Ellipse design (avialable from 3M Company Optical Components Program, Austin, Tex.). Exposure to radiation, preferably ultraviolet radiation, produces a change in birefringence in the portion of the PM optical fiber radiation tuned according to the process of the present invention.

FIG. 4 provides a schematic representation of an apparatus (40) for radiation tuning a polarization maintaining optical fiber (42). The apparatus includes a translation stage (44) that provides a first clamping point (46) and a second clamping point (48) to hold a fixed length of PM single mode, optical fiber (42). A suitable range of fixed lengths of optical fiber (42) varies between about one millimeter and about eight centimeters. During radiation tuning of birefringence, the translation stage traverses a stationary spot of radiation from an ultraviolet laser (50) operating at a wavelength of 244 nm. The laser light spot illuminates the side of the length of a PM optical fiber (42) using a computer (55) to control scanning at rates of about 0.01 mm/second to about 0.5 mm/second. Optional monitoring of the optical fiber (42) uses light, launched from a light source (52) through a polarizer (54), to produce a polarized light wave entering the polarization maintaining optical fiber (42). A spectrum analyzer (56) detects the output from the optical fiber (42) after it passes through a second polarizer (58). The detector shows changes in the light wave corresponding to the progress of radiation tuning of the optical fiber (42).

Table 2 provides a comparison of the compositions of the selected PM optical fibers identified above.

TABLE 2
Chemical Composition of Selected fibers

| | Stress Composition (mole %) | | | | | Core Composition (mole %) | | | | |
|---|---|---|---|---|---|---|---|---|---|---|
| Fiber Number | GeO₂ | SiO₂ | F | B₂O₃ | P₂O₅ | GeO₂ | SiO₂ | F | B₂O₃ | P₂O₅ |
| 1 | 8.08 | 67.97 | 0.00 | 22.43 | 1.21 | 3.40 | 95.92 | 0.35 | 0.20 | 0 |
| 2 | 4.87 | 72.11 | 0.32 | 21.34 | 1.11 | 4.72 | 94.76 | 0.17 | 0.13 | 0.02 |
| 3 | 3.74 | 84.15 | 0.50 | 10.18 | 1.25 | 5.06 | 94.33 | 0.25 | 0.15 | 0.03 |
| 4 | 10.73 | 57.04 | 0.18 | 30.60 | 0.91 | 3.77 | 95.82 | 0.25 | 0.02 | 0.02 |
| 5 | 0.03 | 78.21 | 0.09 | 21.18 | 0.06 | 5.36 | 94.45 | 0.08 | 0.02 | 0.00 |
| 6 | 0.00 | 78.26 | 0.00 | 21.45 | 0.01 | 4.10 | 95.53 | 0.00 | 0.23 | 0.01 |
| 7 | 0.00 | 82.27 | 0.13 | 13.36 | 4.00 | 5.85 | 93.25 | 0.40 | 0.10 | 0.01 |

As discussed previously, the term “stress composition” refers to the composition of the cladding of a PM optical fiber having at least one cladding layer that causes stress induced birefringence in the substantially circular core of the optical fiber. The stress compositions of known PANDA, BOW-TIE and Stress Ellipse types of PM optical fiber differ in that the Stress Ellipse includes germanium in the stress composition as well as in the core composition. Addition of germanium containing dopant compositions to optical fiber core compositions is well known and has provided optical fibers having photosensitivity to ultraviolet radiation. Photosensitive optical fibers have been used extensively for fabrication of a range of fiber optic devices using e.g. periodic variation of refractive index to provide refractive index gratings or Bragg gratings.

Optical fibers using stress ellipse designs typically incorporate a depressed index inner cladding to shield the optical signal from the highly attenuating compositions of the stress layer and to minimize bending loss. The inner cladding may contain fluorine to lower refractive index, and small amounts of phosphorus oxide, which raises refractive index, and chlorine. PANDA and BOW-TIE designs have no circular, depressed inner cladding, but their structures still provide separation between the core and the stress rods and arcuate elements respectively.

There are reports of germanium doped versions of PM optical fibers of PANDA and BOW-TIE types (see for example, Sasaki et al., Electronics Letters, Vol. 20, No. 19, 1984, page 784; and Shibata et al., Journal of Lightwave Technology, Vol. LT-1, No. 1, March 1983, page 38). However, such doped fibers do not appear to be commercially available currently. For this reason, the fabrication of PM fibers including radiation tuned portions deals herein primarily with PM optical fibers of the Stress Ellipse type. Optical fibers including a stress ellipse have been shown to exhibit radiation tuned birefringence. This behavior has been attributed to the presence of germanium in the asymmetric stress zone (36) of the cladding (32, 36, 38). Current findings suggest that changes in composition of components of all types of PM optical fibers will produce radiation tunable versions of those optical fibers. While germanium appears to enhance absorption of radiation, other dopants could contribute to stress composition sensitization that leads to radiation tunable birefringence in PM optical fibers.

The process of radiation tuning of birefringence in PM optical fibers according to the present invention involves a process of side exposure of an optical fiber to ultraviolet radiation that modifies the birefringence and beat length of the optical fiber. In particular this technique increases the birefringence of polarization maintaining fibers. A decrease in beat length accompanies the increase in birefringence of optical fiber exposed to the tuning radiation. The exposure technique has application to a wide variety of optical devices obtained by property enhancement of polarization maintaining (PM) and polarizing (PZ) optical fibers.

A method for producing a length of PM optical fiber having a portion of radiation tuned birefringence requires that the portion be exposed to radiation of a wavelength that is absorbed by, for example, the germanium-doped asymmetric stress zone of a cladding layer of the optical fiber. Removal of coatings from a length of optical fiber may be required before proceeding with radiation tuning. The method (see FIG. 4) uses a translation stage that provides clamping points to hold a fixed length of PM single mode, optical fiber. A range of radiation-tuned lengths of optical fiber between about one millimeter and about eight centimeters was investigated. It will be appreciated that any length of an optical fiber could be radiation tuned depending on the constraints of the exposure equipment.

During radiation tuning of birefringence, the translation stage oscillates in front of a stationary spot of high intensity radiation from an ultraviolet laser operating at a wavelength of 244 nm and up to 500 mW power. The laser light spot was from about 100 μm to about 300 μm perpendicular to the optical fiber and about 900 μm parallel to the length of a PM optical fiber. Laser light spot size may be further varied depending on the characteristics of an optical fiber and the exposure apparatus. Radiation tuning involved scanning of the laser beam at a fixed rate, of about 0.01 mm/second to about 0.5 mm/second, parallel to the length of the optical fiber at incident power levels from about 200 mW to about 300 mW. Calculation of the maximum delivered dose results from multiplying the beam diameter, parallel to the optical fiber, by the peak intensity and dividing by the scan speed. Differences in the perpendicular component of spot size make it inappropriate to compare results obtained with different sample sets. In some instances, a smaller, 100 μm spot may be selected to deliver a larger dose in less time. Alternatively, a larger, 300 μm spot size may be selected to provide more uniform exposure of a PM optical fiber. Other variations of scan rate may be used without departing from the scope of the present invention.

As indicated previously the majority of PM optical fibers exposed to a beam of ultraviolet radiation were of the stress ellipse type available from 3M Company, Optical Components Program, Austin, Tex. An elliptical stress region in the intermediate cladding creates birefringence in the wave-guiding substantially circular core of the optical fiber. This stress layer varies in composition for different PM and PZ products, but in general contains a significant amount of boron with germanium and phosphorus co-doping to control refractive index. These compositions are known for their photosensitivity, having an absorption peak in the 240 nm region of the spectrum. Absorption of ultraviolet radiation in the cladding of a PM optical fiber causes a change in the index of refraction associated with changes of stress region that causes the initial birefringence of the circular core to differ from the birefringence inside the optical fiber portion that was treated with ultraviolet radiation.

It is known that the birefringence of germanium doped optical waveguides changes during exposure to ultraviolet radiation. This is typically viewed as an undesirable phenomenon affecting optical waveguides of inherently low birefringence. For example, an increase in birefringence is undesirable during manufacture of refractive index gratings, such as Bragg gratings. Periodic variation of birefringence is, however, desirable during formation of a rocking filter using an optical fiber having a birefringent elliptical core, for example. A disadvantage of a core of elliptical cross section is the difficulty of accurate core alignment and minimum loss during splicing of optical fiber ends.

The difference between optical fibers according to the present invention and previously investigated photosensitive optical fibers resides in the fact that periodic changes of grating refractive index or rocking filter birefringence and rotation of polarization axes are known to occur in the core of the optical fiber. Available information concerning rocking filters does not suggest an optical fiber structure including an asymmetric stress zone. Conversely, radiation tuning of PM optical fibers, according to the present invention, appears to result from a change in the asymmetric stress region of a cladding layer. Although not wishing to be bound by theory, changes of stress in the cladding layer induce changes of birefringence in the substantially circular core of the PM optical fiber.

Single mode, PM optical fibers have a characteristic beat length that is dependent upon the birefringence of the optical fiber. Changes in beat length may be followed using a magneto-optic modulation technique described by Zhang and Irvine-Halliday, Journal of Lightwave Technology, Vol. 12, No. 4 pages 597-602 (April 1994). In contrast to interferometric techniques that require several meters of optical fiber, the magneto-optic modulation technique closely examines a few centimeters of fiber, and thus is effective for detecting small changes in an affected short length of the birefringent optical fiber. A magnetic field, applied to a localized region of a PM optical fiber, uses the Faraday effect to rotate the plane of polarized light passing through the optical fiber. The magnetic field traverses a test length of the optical fiber during measurement of power output as a function of fiber length. A visual image of power output appears on a display screen as an oscillating power spectrum that may be used to determine the beat length of the optical fiber.

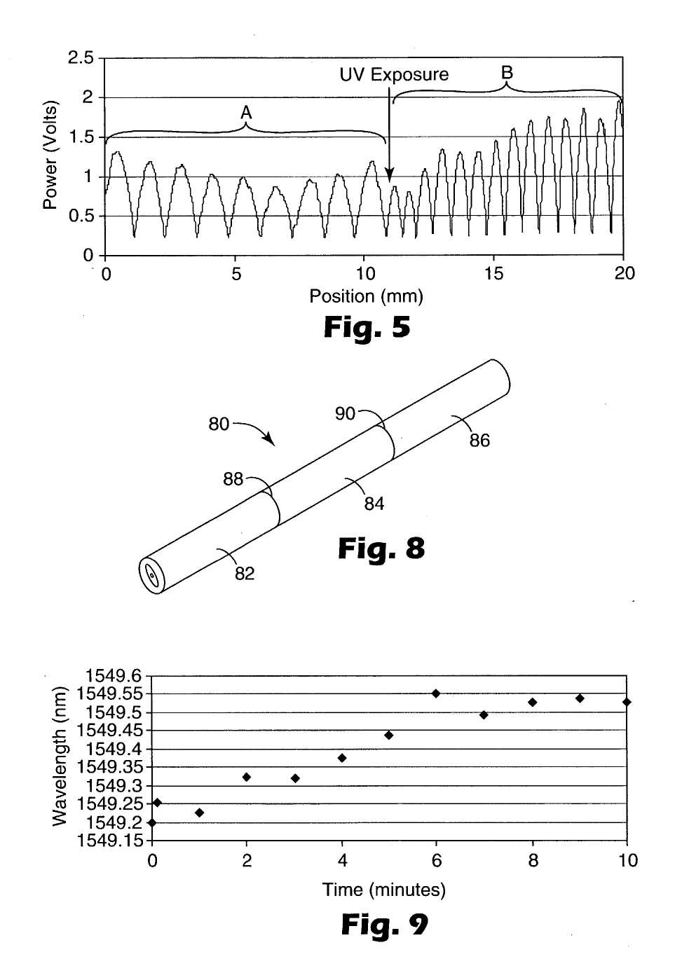

FIG. 5 provides a typical trace showing the onset of increased birefringence corresponding to the point at which a test fiber was radiation tuned. A length of 20 mm of optical fiber was scanned using the magneto-optic modulation technique described previously. The trace clearly shows that the first 10 mm portion (A) of the scan had a first peak separation corresponding to the beat length of the birefringent optical fiber before radiation tuning. During the scan, the equipment detected a second 10 mm portion (B) that exhibited a second peak separation less than the first. The downward pointing arrow identifies the point of demarcation between the unexposed optical fiber and the radiation tuned, exposed portion of the optical fiber. A lowering of beat length corresponds to an increase of birefringence associated with side exposure of the optical fiber to actinic radiation, preferably ultraviolet radiation.

Beat length is calculated by dividing the wavelength of the light by the birefringence of the optical fiber. The resulting value of beat length provides a measure of the phase relationship between orthogonally polarized modes traveling through a PM optical fiber. Radiation tuning of birefringence coupled with monitoring of beat length provides a tool for accurately adjusting the birefringence of an optical fiber to obtain a desired beat length. The fabrication of an optical device may include suitable monitoring of optical properties during exposure of a selected length of PM optical fiber to actinic radiation, preferably ultraviolet radiation. Optical property monitoring facilitates adjustment of birefringence and, as needed, the length of optical fiber exposed until the device satisfies desired optical performance requirements.

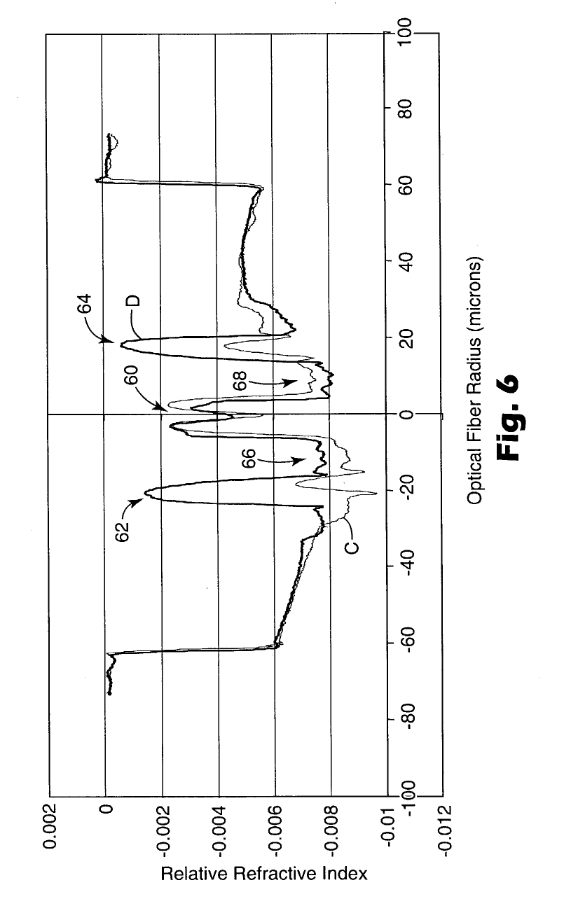

FIG. 6 shows the result of measuring across the width of a Stress Ellipse type of optical fiber to reveal the refractive indices of the core and cladding layers. The refractive index measurement was conducted before and after radiation tuning and annealing of a hydrogen loaded PM optical fiber having a germanium doped elliptical cladding layer. A double peak (60) at the center of the diagram corresponds to the refractive index of the core showing a bum-off dip between two maxima. The intensity of this peak (60) remains essentially unchanged, within instrument resolution, relative to the baseline for traces C and D. Trace C shows the refractive indices of the unexposed optical fiber, while trace D show the change of refractive index after radiation tuning by side exposure of a Stress Ellipse type of optical fiber. Two peaks (62, 64) showed a dramatic increase in refractive index. These peaks (62, 64) lie outside of low refractive index sections (66, 68) that correspond to the depressed index inner cladding layer (34) surrounding the core (32) of a Stress Ellipse type of optical fiber (30), as shown in FIG. 3. FIG. 6 suggests that a change in refractive index of the elliptical cladding layer (36) accompanies radiation tuning of the optical fiber, which produces an increase of birefringence and reduction in beat length of the optical fiber (30).

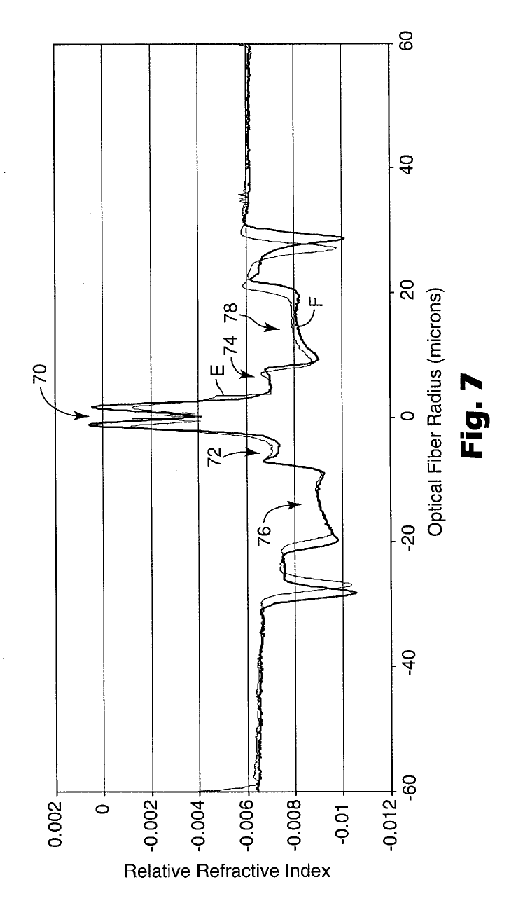

FIG. 7 illustrates the result of repeating refractive index measurement across a PM optical fiber. The test optical fiber, also of the Stress Ellipse type, in this case included a stress ellipse essentially free from germanium dopant. As before, testing provided a trace of refractive index change across the width of the test optical fiber. Trace E shows the refractive index profile of an unexposed optical fiber, while trace F is that for the same optical fiber following side-exposure to ultraviolet radiation. Compared to FIG. 6, FIG. 7 shows a similar dual central peak (70) of high refractive index for the optical fiber core (32). The refractive index of the inner cladding (34) is seen as a first shoulder (72) and a second shoulder (74). Lower refractive index wells (76, 78) represent the refractive index of the elliptical cladding layer (36). After side-exposure of the test optical fiber to ultraviolet radiation, the only apparent difference between traces E and F is a slight increase in the refractive index peak (70) of the optical fiber core (32). This slight increase is typical for optical fibers containing a photosensitive, germanium doped, substantially circular optical fiber core.

Radiation tuning of a PM optical fiber, revealed by beat length change in FIG. 5 and refractive index change in FIG. 6, may be further confirmed by monitoring the change in birefringence of PM fibers having portions exposed to suitable actinic radiation. Table 3 provides results from samples of polarization maintaining optical fiber of the Stress Ellipse type (Fiber 1), which were radiation-tuned by exposure to ultraviolet radiation. Following comparison of an exposed section of optical fiber with an immediately adjacent, unexposed section, the results show a significant change of birefringence of radiation-tuned portions of optical fibers exposed to various doses of ultraviolet radiation. Variation in conditions for optical fiber forming could explain observed differences of a few percent in birefringence change for optical fibers exposed to equal doses of radiation. An increase in birefringence, like the refractive index change, appears to occur by some change in the elliptical cladding rather than the fiber core. Further evidence of this was the discovery of radiation tuning even though very weak refractive index gratings could not be written in the core of an optical fiber hydrogen loading to improve core sensitivity to ultraviolet radiation.

TABLE 3
Results for Examples 1-6 of a Germanium Doped Stress Ellipse PM Fiber

| | | Initial | Final | Birefringence | |
|---|---|---|---|---|---|
| | | birefringence | birefringence | Increase | Birefringence |
| Sample | Dose (kJ/cm²) | (×10⁻⁴) | (×10⁻⁴) | (×10⁻⁴) | Change |
| 1 | 23.2 | 4.134 | 5.323 | 1.189 | 29% |
| 2 | 17.4 | 4.105 | 5.236 | 1.131 | 28% |
| 3 | 17.4 | 4.161 | 5.478 | 1.317 | 32% |
| 4 | 11.6 | 4.170 | 4.938 | 0.768 | 18% |
| 5 | 11.6 | 4.253 | 4.894 | 0.641 | 15% |
| 6 | 5.57 | 4.052 | 4.250 | 0.198 | 5% |

Table 4 includes results from samples of a polarization maintaining fiber (Fiber 3) designed with a smaller stress ellipse for fabrication of fused fiber couplers. Upon exposure to ultraviolet radiation, this optical fiber, which has a relatively low initial birefringence, shows increases to a final birefringence almost 100% greater than initial values.

TABLE 4
Increased Birefringence in Long Beat Length Coupler Fibers (Fiber 3)

| | | Initial | Final | Birefringence | |
|---|---|---|---|---|---|
| | Dose | Birefringence | Birefringence | Increase | Birefringence |
| Example | (kJ/cm²) | (×10⁻⁴) | (×10⁻⁴) | (×10⁻⁴) | Change |
| 7 | 25 | 0.73 | 1.38 | 0.65 | 88% |
| 8 | 25 | 0.73 | 1.39 | 0.66 | 90% |
| 9 | 20 | 0.68 | 1.23 | 0.55 | 80% |
| 10 | 20 | 0.68 | 1.31 | 0.63 | 91% |
| 11 | 15 | 0.79 | 1.26 | 0.47 | 60% |
| 12 | 10 | 0.78 | 1.21 | 0.43 | 55% |
| 13 | 5 | 0.81 | 1.11 | 0.30 | 37% |
| 14 | 5 | 0.81 | 1.12 | 0.31 | 39% |

Table 5 shows changes in birefringence for a polarizing fiber (Fiber 4) that was exposed to ultraviolet radiation. Example 19, exposed to a dose of ultraviolet radiation of 18 kJ/cm², showed the largest absolute change in birefringence of 2.4×10⁻⁴ as well as the highest observed value of birefringence, i.e. 1.2×10⁻³.

TABLE 5
Increase Birefringence In Polarizing Fiber (Fiber 4)

| | | Initial | Final | Birefringence | |
|---|---|---|---|---|---|
| | | birefringence | birefringence | Increase | Birefringence |
| Example | Dose (kJ/cm²) | (×10⁻⁴) | (×10⁻⁴) | (×10⁻⁴) | Change |
| 15 | 18 | 9.913 | 12.31 | 2.40 | 24% |
| 16 | 18 | 9.756 | 11.46 | 1.70 | 17% |
| 17 | 6 | 9.831 | 11.17 | 1.34 | 14% |
| 18 | 6 | 9.726 | 11.40 | 1.67 | 17% |
| 19 | 6 | 9.723 | 10.89 | 1.17 | 12% |

Following study of PM optical fibers having a germanium doped cladding layer there is reinforcing evidence, from measurement of beat length, refractive index and birefringence, that optical fiber wavelength transmission characteristics may be altered selectively by side-exposure of an optical fiber to actinic radiation. Actinic radiation, preferably ultraviolet radiation, causes a relative phase shift between polarization modes passing through a radiation-tuned PM optical fiber. As indicated above, magneto optic coupling is one method providing feedback of radiation tuning according to the present invention. Other methods, including the use of optical spectrum analyzers, may be selected for device dependent precise tuning of spectral characteristics, for example. Precise tuning facilitates adjustment of the characteristics of PM optical fibers that previously relied upon techniques such as controlled cleaving of optical fibers to lengths required for reliable, accurate operation of a variety of fiber optic devices including optical filters and sensors.

Radiation tuning of PM optical fibers has application to optical devices known as Lyot filters, which represent one type of filter device in the category known as birefringent filters. The underlying principle of a birefringent filter is that light originating in a single polarization state can be made to interfere with itself. An optically anisotropic, birefringent medium can be used to produce a relative delay between ordinary and extraordinary rays aligned along the fast and slow axes of the birefringent structure.

In its simplest form, a Lyot filter uses an entrance polarizer separated by a retarder from an exit polarizer. A Lyot filter is conceptually the easiest of the birefringent filters to understand and forms the basis for many variants. The entrance polarizer is oriented 45° to the fast and slow axes of the retarder so that the linearly polarized, ordinary and extraordinary rays have equal intensity. The time delay through a retarder of pathlength d of one ray with respect to the other is simply d Δn/c where Δn is the difference in refractive index between the fast and slow axes. The combined beam emerging from the exit polarizer shows a series of intensity variations described by I² cos(2πd Δn/λ) where I is the wave amplitude. It is possible to isolate an arbitrarily narrow spectral band-pass by placing a number of birefringent retarders in a sequence where each retarder has half the pathlength of the preceding retarder. Successive narrowing of spectral band-pass employs a polarizer between each retarder so that the exit polarizer for any polarizer/retarder/polarizer (P/R/P) segment of the filter structure serves as the entrance polarizer for the next segment. The transmission profile and resolution of a simple Lyot cascade depend upon the number of P/R/P segments and the retarder of longest pathlength respectively. Using multiple segments, the polarizers align with each other and have an orientation of 45° to the retarders.

Lyot filters according to the present invention are compact devices constructed by splicing a section of PZ optical fiber at either end of a length of PM optical fiber. The PZ optical fibers provide the entrance and exit polarizers before and after the length of PM optical fiber that provides the retarder element of a P/R/P segment. There is an angle of orientation of 45° between the axes of the PM fiber and the PZ fibers to provide a structure analogous to a polarizer, half wave plate, and another polarizer in sequence. The output of a Lyot filter, also referred to herein as an all-fiber Lyot filter, is a periodic series of spectral peaks. An all-fiber Lyot filter according to the present invention provides control of the spectral peaks as a function of the length of the PM optical fiber and the total amount of birefringence. The length of the PM optical fiber section controls the period of wave oscillations having exact spectral peak positioning determined by the product of the precise length of PM fiber multiplied by the amount of birefringence. An advantage of radiation tuning of an all-fiber construction is the capability to precisely tune the position of the spectral peak after roughly setting the period of the peaks by the length of PM fiber separating the PZ sections of the filter. Splicing of the PZ optical fiber sections to the PM optical fiber, before exposure of the PM section to ultraviolet radiation, produces a tunable filter structure with subsequent increased precision of peak positioning. This means that exposure of the PM section to ultraviolet radiation increases the birefringence of the filter, thereby facilitating precise control of the spectral properties of the device.

FIG. 8 provides an illustration of an all-fiber Lyot filter (80) including three optical fiber sections of an entry PZ optical fiber (82), a central PM optical fiber (84) and an exit PZ optical fiber (86), which together provide a P/R/P segment. The sections (82, 84, 86) of a P/R/P segment may be constructed by forming a first splice (88) and a second splice (90) after roughly adjusting the length of the PM section (84) to a length that will give the desired light output characteristics. It will be appreciated that the PM optical fiber section (84) may be radiation tuned to precise wavelength characteristics after splicing the entry PZ optical fiber (82) and the exit PZ optical fiber (86) to the PM optical fiber (84) such that the polarization axis of each PZ optical fiber (82, 86) is at a selected angle (e.g. 45°) to the orthogonal polarization axes of the PM optical fiber (84).

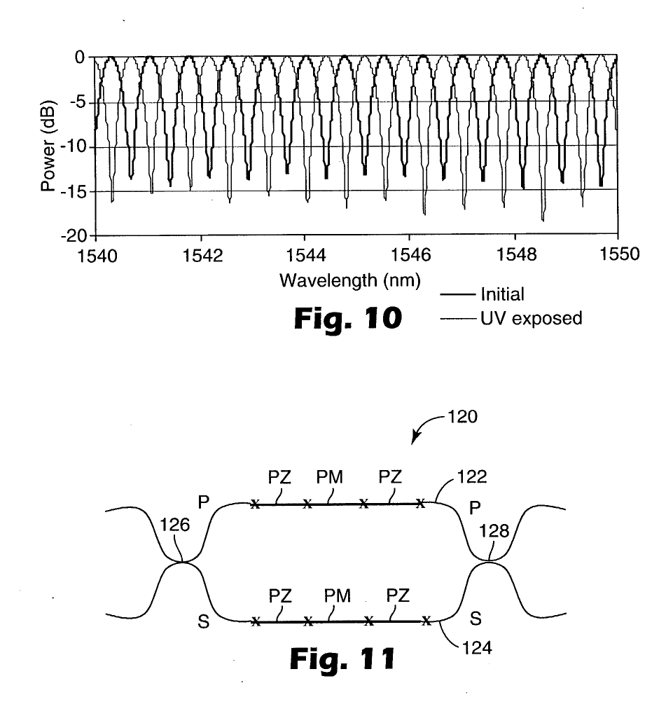

FIG. 9 shows the change in output wavelength during radiation tuning of a portion of the PM section of optical fiber in an all-fiber Lyot filter that provides wavelength spacing less than 0.8 nm. Radiation tuning of the PM optical fiber included side exposure of an optical fiber portion to a beam of ultraviolet radiation from a continuous, frequency doubled, argon ion laser operating at 244 nm, with a peak intensity of 1.5 kW/cm². The laser beam profile was Gaussian, with an 1/e² diameter of 950 microns along the fiber axis. These conditions caused a wavelength shift due to increased birefringence that reached saturation after approximately seven minutes of exposure. The wavelength peak shifted by about 0.35 nm, which is approximately half the period of the series of wavelength peaks shown in FIG. 10 for a filter that includes a PM optical fiber having a length of approximately seven meters. In this case, the PM optical fiber was radiation tuned only along the portion of a few millimeters that was stripped of protective polymer coating in preparation for splice formation with PZ optical fiber end sections. After splicing the all-fiber Lyot filter together, exposure to tuning radiation of the length of bare PM optical fiber at one splice was sufficient to provide an increase in birefringence and a shift of one half period in wavelength peak. If necessary, the second splice could be radiation tuned to further shift the wavelength peak. Radiation tuning by exposing only the splices of the all-fiber Lyot filter provides a device reliability and manufacturing advantage since polymer stripping and recoating is limited to spliced portions of P/R/P segments.

Since changes in temperature will influence the length and birefringence of a P/R/P filter segment, birefringent filters may need to be housed in packages that can control the temperature or somehow compensate for the changes. The use of radiation tuned PM optical fibers appears to lessen this requirement since it has been demonstrated that radiation tuned portions of PM and PZ optical fibers are less sensitive to change in temperature than similar untreated optical fibers. This observation suggests the option of exposing long lengths of optical fiber to reduce temperature sensitivity for the entire length of optical fiber treated by exposure to radiation. Alternatively, small sections of optical fiber, used in devices such as couplers or fiber lenses may be suitably treated to reduce device sensitivity to temperature variation.

Samples of two stress ellipse optical fiber sections were exposed to ultraviolet radiation from a continuous, frequency doubled, argon ion laser operating at 244 nm to increase the birefringence of each section of optical fiber. The temperature dependence of the birefringence was measured and compared to results of untreated fiber. A Sagnac filter was formed by connecting the polarization maintaining optical fiber to the outputs of a 3dB single mode fiber based coupler. The two inputs of the 3 dB coupler were connected to an optical source and an optical spectrum analyzer whereby the optical spectrum analyzer detected a sinusoidal wavelength pattern. Temperature dependence of birefringence of the optical fiber was calculated from the shift in the sinusoidal wavelength pattern during temperature testing that included placing the optical fiber in a variable temperature chamber. Testing results for the coupler fiber (Fiber 2) showed decreased dependence of birefringence on temperature after radiation tuning.

The dependence of birefringence with temperature remained essentially unchanged whether or not the exposed optical fiber was annealed at 120° C. for 12 hours.

Table 6 includes the results of temperature testing of Fiber 2 before and after exposure to birefringence modifying radiation.

TABLE 6
Temperature Dependence of Birefringence Before and After UV Exposure

| | |
|---|---|
| Fiber | Fiber 2 |
| Initial Birefringence | 2.95 × 10⁻⁴ |
| Initial temperature dependence (° C.⁻¹) | −2.98 × 10⁻⁷ |
| Radiation dose | 25 kJ/cm² |
| Final Birefringence | 5.07 × 10⁻⁴ |
| Change in Birefringence | 72% |
| Final temperature dependence (° C.⁻¹) | −2.00 × 10⁻⁷ |

Lyot filters may be constructed by cascading several PZ-PM-PZ-PM-PZ segments in which each succeeding segment has an optical length that is half that of the previous segment. This results in filters that have narrow pass bands with wider separation of spectral peaks. Certain devices, such as interferometers, require optical path lengths to be adjusted to within a fraction of a wavelength. Such precision is beyond the manufacturers' ability to cut the fiber to the correct length and fusion splice it to the other elements in a fiber optic device. The ability to radiation tune waveguide properties to required tolerances after connecting optical fiber segments together, e.g. by splicing, is particularly advantageous.

Other combinations of types of optical fibers fall within the scope of the present invention wherein, for example, previously described, cascading multiple segments of optical fiber could be constructed and suitably radiation tuned. Radiation tuning by exposure to suitable actinic radiation provides an effective facile approach to controlling both the spacing and position of spectral peaks by precisely controlling the beat length of one or more segments of PM optical fiber to tolerances of a fraction of a millimeter. Alternative means for control of birefringence include external mechanical packaging and optical fiber cleaving. The use of external mechanical packaging, where compression of the PM fiber modifies the birefringence, adds bulk to the device while reducing reliability and possibly inducing microbending loss. Optical fiber cleaving (See U.S. Pat. No. 6,535,654 B1) to length tolerances less than one millimeter are clearly prone to error, making this approach inferior to radiation tuning of birefringence.

Precise positioning of spectral peaks using radiation tuning has application in a variety of systems and devices that may employ optical filters. Exemplary devices include add-drop multiplexers and demultiplexers, and interleavers in wave division multiplexed (WDM) optical communications systems. An all-fiber Lyot filter as described above could replace known optical fiber devices. By providing extremely small channel spacings, typically less than 50 MHz, there is potential for replacing thin-film filters, which are difficult to fabricate. Also, replacement of fiber Bragg gratings may be possible using an all-fiber filter that, unlike a Bragg grating, does not require a circulator to function as a filter for a wave division multiplexed signal.

As a further example of a tunable filter is a fiber-optic polarimetric interferometer. U.S. Pat. No. 6,266,458 includes discussion of a tunable fiber optic polarimetric interferometer using at least one PM optical fiber. The tunable system includes a phase modulator using an electro-optic effect to adjust the length of the optical fiber in response to feedback from device stabilization electronics. Modulator adjustment compensates for external perturbations of the polarimetric interferometer to maintain a constant phase difference between two optical paths in the PM optical fiber. While reacting to changes in device characteristic, after initial set-up, there is no arrangement for pre-tuning the output of the interferometer, as would be possible using radiation tuning according to the present invention.

FIG. 11 provides a schematic diagram of a device (120) that incorporates a first optical fiber arm (122) and a second optical fiber arm (124) to provide a structure analogous to devices such as a Mach-Zehnder interferometer, although the device of the present invention is non-interferometric. Each of the first (122) and second (124) optical fiber arms has a central PM optical fiber section spliced between two PZ optical fiber sections. The PZ-PM-PZ fiber configuration, shown in FIG. 8, has an insertion loss dependent upon the polarization state of the input light and provides a polarized output.

Incorporation of input (126) and output (128) polarization beam splitters produces a device (120) that is polarization independent having each arm tuned separately for overlap of the wavelength spectrum of each polarization. For device simplification, it is possible to remove the first PZ section from each of the first (122) and second (124) optical fiber arms since the input polarization beam splitter (126) acts as a polarizer for each arm of the device (120). The device (120) is non-interferometric in nature whether or not the first PZ section of optical fiber is present in each arm (122, 124) of the optical fiber system. This provides an advantage for the device illustrated in FIG. 11 compared to e.g. a Mach-Zehnder optical add/drop device.

As required, details of the present invention are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present invention.

1. A radiation tuned optical fiber comprising:
an optical fiber including a core and a cladding containing an asymmetric stress zone, said core having an initial birefringence and wherein said asymmetirc stress zone contains a phostosensitive dopant composition; and
at least one radation-turned portion wherein said core has a tuned birefringence to provide said radiation tuned optical fiber wherein said tuned birefringence differs from said initial birefringence.

2. The radiation tuned optical fiber of claim 1, wherein said asymmetric stress zone causes said initial birefringence in said core.

3. The radiation tuned optical fiber of claim 1, wherein said core has a substantially circular cross section.

4. The radiation tuned optical fiber of claim 3, wherein said substantially circular cross section has an ellipticity less than about 40%.

5. The radiation tuned optical fiber of claim 1, wherein said cladding includes a plurality of stress rods producing said asymmetric stress zone.

6. The radiation tuned optical fiber of claim 1, wherein said cladding includes a plurality of arcuate stress elements producing said asymmetric stress zone.

7. The radiation tuned optical fiber of claim 1, having said cladding disposed elliptically around said core to provide said asymmetric stress zone.

8. The radiation tuned optical fiber of claim 1, wherein said tuned birefringence differs from said initial birefringence by an amount up to about 2.5×10⁻⁴.

9. The radiation tuned optical fiber of claim 1, wherein said tuned birefringence is higher than said initial birefringence.

10. The radiation tuned optical fiber of claim 9, wherein said tuned birefringence is from about 5% to about 100% bigher than said initial birefringence.

11. (Canceled)

12. The radiation tuned optical fiber of claim 1, wherein said photosensitive dopant composition contains a germanium compound.

13. The radiation tuned optical fiber of claim 1, wherein said optical fiber is a single mode optical fiber.

14. The radiation tuned optical fiber of claim 13, wherein said single mode optical fiber is a polarization maintaining optical fiber.

15. The radiation tuned optical fiber of claim 13, wherein said single mode optical fiber is a polarizing optical fiber having a substantially single axis of polarization.

16. The radiation tuned optical fiber of claim 1, wherein said tuned birefringence has less dependence on temperature than said initial birefringence.

17. A process for producing a radiation tuned optical fiber comprising the steps of:
providing an optical fiber including a core, a cladding containing an asymmetic stress zone and at least one coating covering said cladding, said core further having an initial birefringence and wherein said asymmetric stress zone contains a photosensitive dopant composition; and
exposing a portion of at least one section of said optical fiber to actinic radiation to provide at least one radiation tuned portion of said at least one section, such that said core has a tuned birefringence to provide said radiation tuned optical fiber wherein said tuned birefringence differs from said initial birefringence.

18. The process of claim 17, further comprising the step of removing said at least one coating from said at least one section of said optical fiber.

19. The process of claim 17, further comprising the step of annealing said radiation tuned optical fiber.

20. The process of claim 17, wherein said actinic radiation is ultraviolet radiation.

21. The process of claim 17, wherein said exposing a portion uses a laser beam of said actinic radiation.

22. The process of claim 17, wherein said asymmetric stress zone causes said initial birefringence in said core.

23. The process of claim 17, wherein said cladding includes a plurality of stress rods producing said asymmetic stress zone.

24. The process of claim 17, wherein said cladding includes a plurality of arcuate stress elements producing said asymmetric stress zone.

25. The process of claim 17, having said cladding disposed elliptically around said core to provide said asymmetric stress zone.

26. The process of claim 17, wherein said tuned birefringence is higher than said initial birefringence.

27. The process of claim 26, wherein said tuned birefringence is from about 5% to about 100% higher than said initial birefringence.

28. (Canceled)

29. The process of claim 17, wherein said photosensitive dopant composition contains a germanium compound.

30. The process of claim 17, wherein said optical fiber is a single mode optical fiber.

31. The process of claim 30, wherein said single mode optical fiber is a polarization maintaining optical fiber.

32. The process of claim 30, wherein said single mode optical fiber is a polarizing optical fiber having a substantially single axis of polarization.
